(19) United States
(12) Patent Application Publication
(10) Pub. No.: US 2019/0202137 A1
(43) Pub. Date: Jul. 4, 2019

(54) Method for Manufacturing a Head of a Golf Club

(71) Applicant: FUSHENG PRECISION CO., LTD, Taipei (TW)

(72) Inventor: Szu-Ying Wu, Taipei (TW)

(21) Appl. No.: 16/128,772

(22) Filed: Sep. 12, 2018

(30) Foreign Application Priority Data
Dec. 29, 2017 (CN) 201711473421.6

(51) Int. Cl. B29C 65/48; A63B 53/04

(52) U.S. Cl. CPC B29C 65/4845; A63B 2102/32; A63B 53/04

(57) ABSTRACT

A method for manufacturing a head of a golf club includes providing a body of the head and a cover. The body has a top surface and an abutment portion. The abutment portion has an abutment face connected to the top surface via a first connection face. The cover has a first face, a second face and a second connection face. The method further includes disposing a first covering member on the top surface of the body, disposing a second covering member on the first face, and applying a pressure to the body and the cover to bond the cover to the abutment portion via an adhesive agent, obtaining a semi-finished product of the head of the golf club. The method further includes heating the semi-finished product to couple the cover with the abutment portion and removing the first and second covering members from the heated semi-finished product.

### CROSS REFERENCE TO RELATED APPLICATION

The application claims the benefit of China application serial No. 201711473421.6 filed on Dec. 29, 2017, and the entire contents of which are incorporated herein by reference.

### BACKGROUND OF THE INVENTION

### 1. Field of the Invention

The present invention generally relates to a method for manufacturing a head of a golf club and, more particularly, to a method for manufacturing a head of a golf club which uses an adhesive agent to couple the components of the head of the golf club with each other.

### 2. Description of the Related Art

Referring to FIGS. 1 and 2, a conventional method for manufacturing a head 9 of a golf club includes providing a body 91 of the head and a cover 92. The body 91 includes an abutment portion 911. An adhesive agent can be applied to the abutment portion 911 or the cover 92. Then, the cover 92 is aligned with the body 91. Next, pressure is applied to both the body 91 and the cover 92 to bond the cover 92 to the abutment portion 911 of the body 91 by the adhesive agent, obtaining a semi-finished product of a golf club head. Next, the semi-finished product of the golf club head is heated to solidify the adhesive agent. The solidified adhesive agent will tightly bond to the abutment portion 911 of the body 91 of the head to thereby obtain the head 9 of the golf club.

However, there inevitably exists a gap G between the body 91 and the cover 92 (as shown in FIG. 2) in order to align the cover 92 with the body 91. Due to this, the adhesive agent that is applied to the abutment portion 911 or the cover 92 can spill over the surface of the head 9 of the golf club from inside the gap G. As a result, extra effort and time are required to clean the head 9 of the golf club. To solve the problem, it is necessary to provide a method for manufacturing a head of a golf club.

### SUMMARY OF THE INVENTION

It is therefore the objective of this invention to provide a method for manufacturing a head of a golf club which reduces the effort and time required to remove the adhesive agent that spills over the surface of the head from inside the gap.

In an aspect, a method for manufacturing a head of a golf club according to the invention includes providing a body of the head and a cover. The body has a top surface and an abutment portion. The abutment portion is in a form of a recess on the top surface. The abutment portion has an abutment face connected to the top surface via a first connection face. The cover has a first face, a second face opposite to the first face, and a second connection face connected between the first face and the second face. The method further includes disposing a first covering member on the top surface of the body, disposing a second covering member on the first face of the cover, and applying a pressure to both the body of the head and the cover to bond the cover to the abutment portion of the body via an adhesive agent, obtaining a semi-finished product of the head of the golf club. The method further includes heating the semi-finished product of the head of the golf club to securely couple the cover with the abutment portion of the body via the adhesive agent, and removing the first and second covering members from the heated semi-finished product of the head of the golf club. Based on this, in the method for manufacturing the head of the golf club according to the invention, the arrangement of the first and second covering members permits the adhesive agent, that spills from inside the gap over the top surface of the body and the first face of the cover, to cover the top surfaces of the first and second covering members. Due to this, the removal of the first and second covering members will also remove the adhesive agent from the gap, the top surface of the body, and the first face of the cover. Advantageously, the effort and time required to remove the adhesive agent is reduced, thereby reducing the manufacturing cost of the head of the golf club.

In the method for manufacturing the head of the golf club according to the invention, the first covering member may be a tape. Alternatively, the first covering member is formed from an ultraviolet light curing adhesive, in which disposing the first covering member includes applying the ultraviolet light curing adhesive to the top surface of the body, and irradiating the body of the head with ultraviolet light to solidify the ultraviolet light curing adhesive as the first covering member. Furthermore, the second covering member may be a tape. Alternatively, the second covering member is formed from an ultraviolet light curing adhesive, in which disposing the second covering member includes applying the ultraviolet light curing adhesive to the first face of the cover; and irradiating the cover with ultraviolet light to solidify the ultraviolet light curing adhesive as the second covering member. In a preferred case, the first covering member covers through the top surface, the first connection face and the abutment face of the body. The second covering member covers the first face and the second connection face of the cover. In this arrangement, the removal of the first and second covering members can remove the adhesive agent from the gap. This not only attains the improved removal effect as desired but also makes the head of the golf club more visually appealing.

In the method for manufacturing the head of the golf club according to the invention, the pressure is 10-25 psi. In this regard, heating the semi-finished product includes heating the semi-finished product of the head of the golf club with a temperature of 121-177° C. for 30-60 minute. In a preferred case, the pressure is 15 psi and heating the semi-finished product includes heating the semi-finished product of the head of the golf club with the temperature of 135-145° C. for 35-45 minute. Alternatively, the semi-finished product of the head of the golf club can be heated with the temperature of 23-85° C. for 10-1440 minute. Preferably, the semi-finished product of the head of the golf club is heated with the temperature of 75-80° C. for 25-35 minute. In this arrangement, through the adjustments of the pressure applied to bond the cover to the abutment portion of the body and the temperature and time required for heating the semi-finished product of the head of the golf club, the adhesive agent can have a better adhesion effect. Advantageously, the structural strength of the head of the golf club is improved.

The method for manufacturing the head of the golf club according to the invention may further include providing a body of the head and a cover. The body has a top surface and an abutment portion. The abutment portion is in a form of a recess on the top surface. The abutment portion has an abutment face connected to the top surface via a first connection face. The cover has a first face, a second face opposite to the first face, and a second connection face connected between the first face and the second face. The method further includes adhering the cover to the abutment portion of the body via an adhesive agent to obtain a semi-finished product of the head of the golf club. The first connection face of the body is spaced from the second connection face of the cover by a gap. The method further includes heating the semi-finished product of the head of the golf club to securely couple the cover with the abutment portion of the body via the adhesive agent, and removing the covering member from the heated semi-finished product of the head of the golf club. Based on this, in the method for manufacturing the head of the golf club, the arrangement of the covering member can prevent the adhesive agent, whose flowability has changed due to the heating process, from flowing into the gap. As a result, the adhesive agent will not reach the top surface of the body of the head and the first face of the cover, reducing the effort and time required to remove the adhesive agent. Advantageously, the manufacturing cost of the head of the golf club is reduced.

In the method for manufacturing the head of the golf club according to the invention, the covering member is formed from an ultraviolet light curing adhesive. In this regard, disposing the covering member includes filling the gap with an ultraviolet light curing adhesive, and irradiating the gap with ultraviolet light to solidify the ultraviolet light curing adhesive as the covering member. In a preferred case, the covering member extends from the gap to the top surface of the body and the first face of the cover. Based on this, since the covering member also covers the top surface of the body and the first face of the cover, the convenience in removal of the covering member from the heated semi-finished product of the head of the golf club can be improved.

The method for manufacturing the head of the golf club according to the invention further includes applying a pressure of 15-50 psi to both the body of the head and the cover to bond the cover to the abutment portion of the body via an adhesive agent. In this regard, the semi-finished product of the head of the golf club can be heated with a temperature of 107-132° C. In this arrangement, through the adjustments of the pressure applied to bond the cover to the abutment portion of the body and the temperature and time required for heating the semi-finished product of the head of the golf club, the adhesive agent can have a better adhesion effect. Advantageously, the structural strength of the head of the golf club is improved.

In the method for manufacturing the head of the golf club according to the invention, the first connection face of the body is spaced from the second connection face of the cover by a gap of 0.1-2 mm. This permits the covering member (or the first and second covering members) to be disposed into the gap more conveniently. As a result, a secure covering effect is attained and it is also possible to remove the at least one covering member from the gap when it is desired.

In the method for manufacturing the head of the golf club according to the invention, the abutment face of the body is spaced from the top surface of the body at a distance of 0.3-0.8 mm. Thus, the cover can be positioned on the body of the head more conveniently.

In the method for manufacturing the head of the golf club according to the invention, the abutment face of the body has a width of 4-7 mm. Thus, the adhesive agent applied between the second face of the cover and the abutment face has a bonding strength of 10-60 MPa.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is an exploded view of a head of a golf club which includes a body and a cover to be coupled with each other using a conventional manufacturing method.

FIG. 2 shows an abutment portion of the body and the cover that are coupled with each other by the conventional manufacturing method.

FIG. 3 is an exploded view of a head of a golf club which includes a body and a cover to be coupled with each other using a manufacturing method according to the invention.

FIG. 4 shows an abutment portion of the body and the cover that are to be coupled with each other by the manufacturing method according to the invention.

FIG. 5 shows an arrangement of first and second covering members on the body of the head and the cover, respectively, according to a first embodiment of the invention.

FIG. 6 shows an arrangement of an adhesive agent according to the first embodiment of the invention.

FIG. 7 shows an arrangement of the adhesive agent spilling out of a gap between the body of the head and the cover according to the first embodiment of the invention.

FIG. 8 shows a removal of the first and second covering members according to the first embodiment of the invention.

FIG. 9 shows an arrangement of an adhesive agent according to a second embodiment of the invention.

FIG. 10 shows an arrangement of a covering member according to the second embodiment of the invention.

FIG. 11 shows a removal of the covering member according to the second embodiment of the invention.

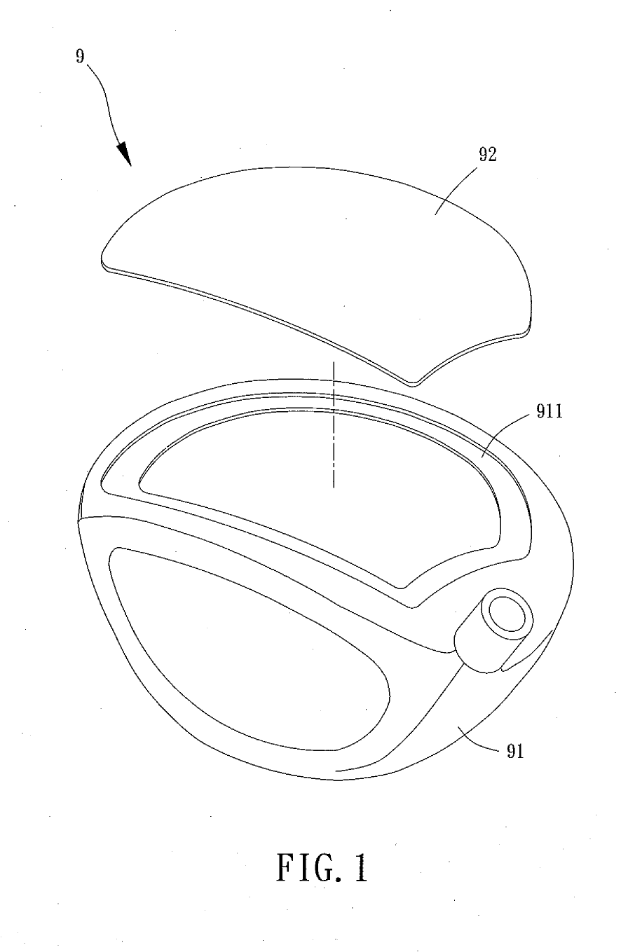

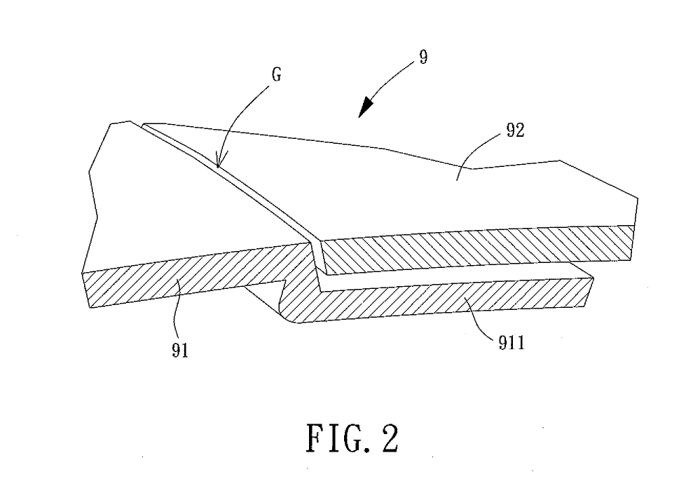

In the various figures of the drawings, the same numerals designate the same or similar parts. Furthermore, when the terms “first”, “second”, “third”, “fourth”, “inner”, “outer”, “top”, “bottom”, “front”, “rear”, “axial”, “radial”, “longitudinal”, “transverse”, “length”, “width”, “height” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

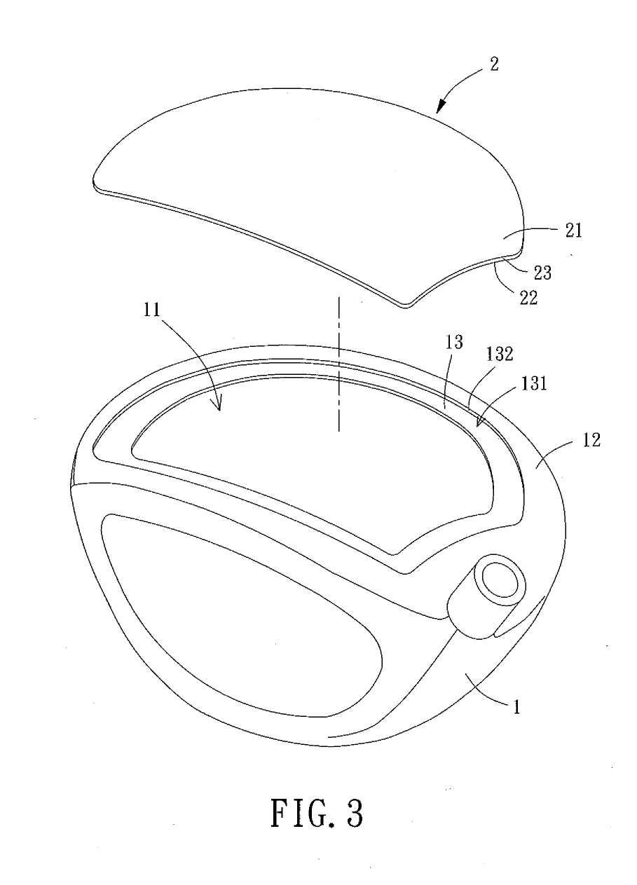

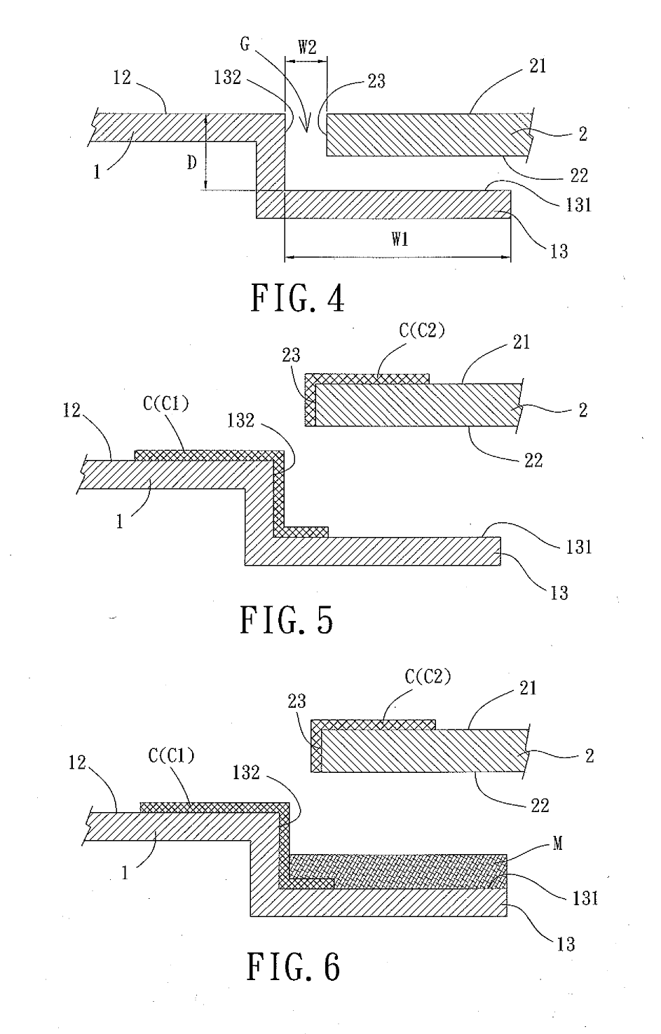

FIGS. 3 and 4 show a method for manufacturing a head of a golf club which uses an adhesive agent to couple a body 1 with a cover 2 to form the head of the golf club, and which uses a covering member to prevent the adhesive agent from spilling over the surface of the head from inside the gap. For example, the cover 2 may be a crown or a sole of a head consisting of multiple components, but is not limited thereto.

Specifically, the body 1 includes an opening 11 having a shape corresponding to the cover 2, as shown in FIG. 3. In an example of a crown, the opening 11 forms a top surface 12 of the body 1. The body 1 includes an abutment portion 13 which is in the form of a recess on the top surface 12. The abutment portion 13 surrounds the opening 11 and includes an abutment face 131 for supporting the cover 2. The abutment face 131 is connected to the top surface 12 via a first connection face 132. In this embodiment, the abutment face 131 is spaced from the top surface 12 at a distance D of 0.3-0.8 mm to permit the cover 2 to be positioned on the body 1 more conveniently. The abutment face 131 of the body 1 has a width W1 of 4-7 mm such that the adhesive agent applied between the cover 2 and the abutment face 131 has a bonding strength of 10-60 MPa.

The cover 2 has a first face 21, a second face 22 opposite to the first face 21, and a second connection face 23 connected between the first face 21 and the second face 22. The size of the cover 2 can be determined based on the size of the abutment portion 13 of the body 1. It is noted that when the cover 2 seals the opening 11 of the body 1, the second connection face 23 of the cover 2 is spaced from the first connection face 132 of the body 1 at a gap G. The gap G is preferably between 0.1-2 mm such that at least one covering member can be disposed into the gap G more conveniently. As a result, a secure covering effect is attained and it is also possible to remove the at least one covering member from the gap G when it is desired.

Referring to FIG. 5, in the first embodiment of the invention, a covering member C can be mounted to each of the top surface 12 of the body 1 and the first face 21 of the cover 2. For the purposes of illustration, the covering member C that is mounted to the top surface 12 of the body 1 is referred to as “first covering member C1” hereinafter, and the covering member C that is mounted to the first face 21 of the cover 2 is referred to as “second covering member C2” hereinafter. The first covering member C1 can cover the top surface 12 only. In a preferred case, the first covering member C1 covers through the top surface 12, the first connection face 132 and the abutment face 131. Furthermore, the second covering member C2 can cover the first face 21 only. In a preferred case, the second covering member C2 covers through the first face 21 and the second connection face 23. This ensures that the first covering member C1 and the second covering member C2 have an excellent covering effect.

The first covering member C1 may be a heat-proof tape, which can be adhered to the top surface 12 of the body 1. Moreover, the first covering member C1 can be formed from an ultraviolet light curing adhesive. The ultraviolet light curing adhesive can be applied somewhere where the first covering member C1 is to be formed. For example, referring to FIG. 3, the ultraviolet light curing adhesive can be applied to the abutment face 131 and the first connection face 132. The ultraviolet light curing adhesive is irradiated with ultraviolet light to solidify the ultraviolet light curing adhesive, forming the first covering member C1. Besides, the second covering member C2 may also be a heat-proof tape or an ultraviolet light curing adhesive. In the case of the ultraviolet light curing adhesive, the ultraviolet light curing adhesive is applied somewhere where the second covering member C2 is to be formed. For example, referring to FIG. 3, the ultraviolet light curing adhesive is applied to the first face 21 and the second connection face 23. Similarly, the ultraviolet light curing adhesive is irradiated with ultraviolet light to solidify the ultraviolet light curing adhesive, forming the second covering member C2.

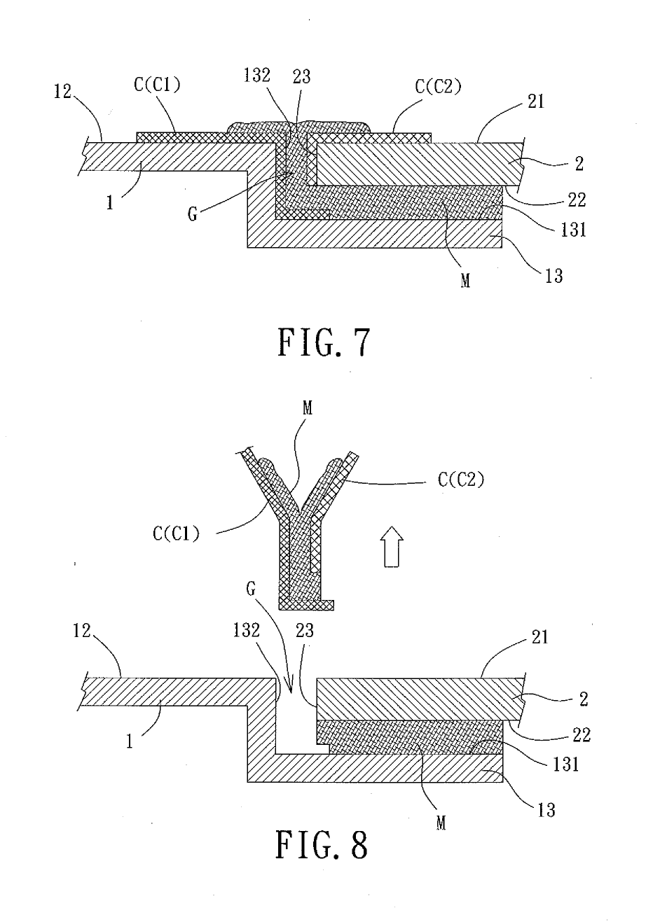

Referring to FIG. 6, an adhesive agent M can be used to bond the cover 2 to the abutment face 131 of the body 1, thereby obtaining a semi-finished product of a golf club head. For example, the adhesive agent M can be adhered to the abutment face 131 of the body 1 as shown in FIG. 6. Alternatively, the adhesive agent M is adhered to the second face 22 of the cover 2. Still alternatively, the adhesive agent M can be adhered to both the abutment face 131 of the body 1 and the second face 22 of the cover 2. Based on the above, pressure is applied to bond the cover 2 to the abutment portion 13 of the body 1, causing the unsolidified adhesive agent M to flow into the gap G and reach the top surface 12 of the body 1 and the first face 21 of the cover 2, as shown in FIG. 7. In this regard, since the top surface 12 of the body 1 is provided with the first covering member C1 and the first face 21 of the cover 2 is provided with the second covering member C2, the unsolidified adhesive agent M will cover the top surfaces of the first covering member C1 and the second covering member C2.

Then, the semi-finished product of the golf club head can be heated to bond the cover 2 to the abutment portion 13 of the body 1 through the adhesive agent M. It is noted that the pressure applied to bond the cover 2 to the abutment portion 13 of the body 1, as well as the temperature and time required to heat the semi-finished product of the golf club head, may vary based on the type of the adhesive agent M used. Assume that the LY2 adhesive (Loctite 9432NA) is used as the adhesive agent M. In this case, both the body 1 and the cover 2 are applied with pressure of 10-25 psi and the semi-finished product of the golf club head is heated under a temperature of 121-177° C. for 30-60 minute. In a preferred case, both the body 1 and the cover 2 are applied with pressure of 15 psi and the semi-finished product of the golf club head is heated under a temperature of 135-145° C. for 35-45 minute. In another case where the DP420 adhesive (3M DP420 NS Black) is used as the adhesive agent M, both the body 1 and the cover 2 are applied with pressure of 10-25 psi and the semi-finished product of the golf club head is heated under a temperature of 23-85° C. for 10-1440 minute. Preferably, both the body 1 and the cover 2 are applied with pressure of 15 psi and the semi-finished product of the golf club head is heated under a temperature of 75-80° C. for 25-35 minute.

After heating the semi-finished product of the golf club head, the first covering member C1 and the second covering member C2 can be removed from the heated semi-finished product of the golf club head as shown in FIG. 8. At the same time, as the first covering member C1 covers through the top surface 12, the first connection face 132 and the abutment face 131 and the second covering member C2 covers through the first face 21 and the second connection face 23, the removal of the first covering member C1 and the second covering member C2 can remove the adhesive agent M from inside the gap G. This not only attains the improved removal effect as desired but also makes the head of the golf club more visually appealing.

Based on the above, with the method for manufacturing the head of the golf club according to the invention, the arrangement of the first and second covering members permits the adhesive agent, that spills from inside the gap over the top surface of the body and the first face of the cover, to cover the top surfaces of the first and second covering members. Due to this, the removal of the first and second covering members will also remove the adhesive agent from the gap, the top surface of the body, and the first face of the cover. Advantageously, the effort and time required to remove the adhesive agent is reduced, thereby reducing the manufacturing cost of the head of the golf club.

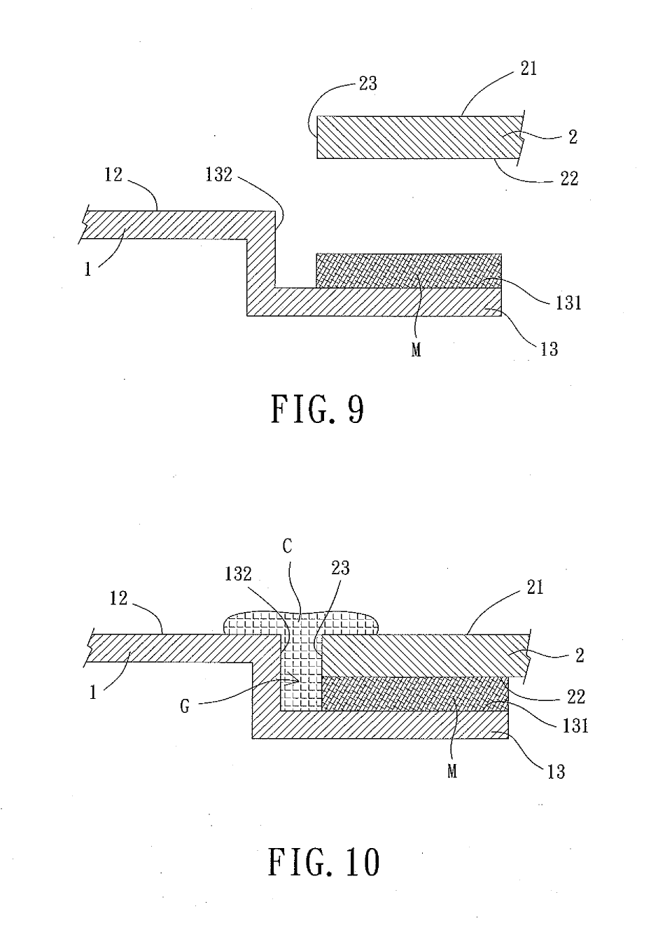

Referring to FIGS. 9 and 10, based on the same technical concept, the second embodiment of the invention requires only one covering member to prevent the adhesive agent from spilling out of the gap G. Specifically, prior to the arrangement of the covering member C, the cover 2 can be coupled to the abutment face 131 of the body 1 via the adhesive agent M to obtain a semi-finished product of a golf club head. At this time, a 3M adhesive film (3M AF163-2) can be used as the adhesive agent M. Both the body of the head and the cover are applied with pressure of 15-50 psi to couple the cover 2 with the abutment portion of the body of the head.

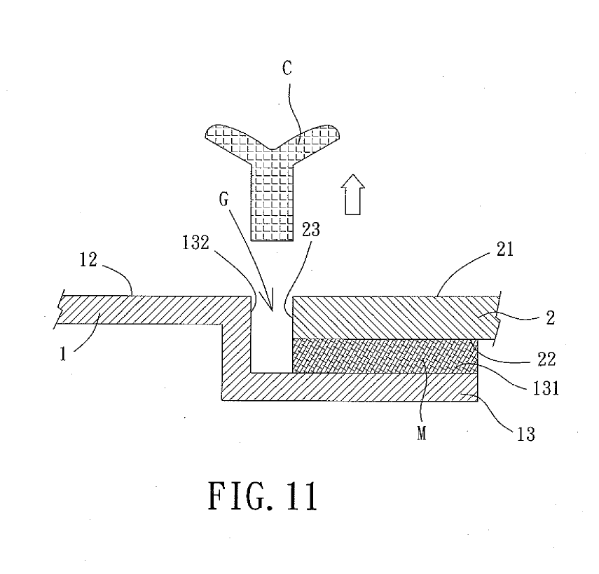

Next, referring to FIG. 11, a covering member C can be disposed in the gap G of the semi-finished product of the golf club head. In a preferred case, the covering member C can extend from the gap G to the top surface 12 of the body 1 and the first face 21 of the cover 2. In the second embodiment, the covering member C can be formed from an ultraviolet light curing adhesive. In this case, the gap G is filled with the ultraviolet light curing adhesive. The ultraviolet light curing adhesive is irradiated with ultraviolet light to solidify the ultraviolet light curing adhesive as the covering member C.

Based on this, the semi-finished product of the golf club head can be heated to securely couple the cover 2 with the abutment portion 13 of the body 1 via the adhesive agent M. In this embodiment, the semi-finished product of the golf club head is heated under a temperature of 107-132° C. for 60-90 minute. As a result, since the gap G is already filled with the covering member C, although there is a change in the flowability of the adhesive agent M, the adhesive agent M will not flow into the gap G nor will it reach the top surface 12 of the top surface 12 and the first face 21 of the cover 2 during the heating of the semi-finished product of the golf club head.

Referring to FIG. 12, after heating of the semi-finished product of the golf club head, the covering member C can be removed from the heated semi-finished product of the golf club head. In this regard, since the covering member C extends through the gap G, the top surface 12 of the body 1 and the first face 21 of the cover 2, the covering member C can be removed conveniently.

Based on the above, with the method for manufacturing a head of a golf club according to the invention, the arrangement of the covering member C can prevent the adhesive agent M, whose flowability has changed due to the heating process, from flowing into the gap G. As a result, the adhesive agent M will not reach the top surface of the body and the first face of the cover, reducing the effort and time required to remove the adhesive agent. Advantageously, the manufacturing cost of the head of the golf club is reduced.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A method for manufacturing a head of a golf club, comprising:
providing a body of the head and a cover, wherein the body has a top surface and an abutment portion, wherein the abutment portion is in a form of a recess on the top surface, wherein the abutment portion has an abutment face connected to the top surface via a first connection face, wherein the cover has a first face, a second face opposite to the first face, and a second connection face connected between the first face and the second face;
disposing a first covering member on the top surface of the body;
disposing a second covering member on the first face of the cover;
applying a pressure to both the body of the head and the cover to bond the cover to the abutment portion of the body via an adhesive agent, obtaining a semi-finished product of the head of the golf club;
heating the semi-finished product of the head of the golf club to securely couple the cover with the abutment portion of the body via the adhesive agent; and
removing the first and second covering members from the heated semi-finished product of the head of the golf club.

2. The method for manufacturing the head of the golf club as claimed in claim 1, wherein the first covering member is a tape.

3. The method for manufacturing the head of the golf club as claimed in claim 1, wherein the first covering member is formed from an ultraviolet light curing adhesive, wherein disposing the first covering member comprises:
applying the ultraviolet light curing adhesive to the top surface of the body; and
irradiating the body of the head with ultraviolet light to solidify the ultraviolet light curing adhesive as the first covering member.

4. The method for manufacturing the head of the golf club as claimed in claim 2, wherein the first covering member covers through the top surface, the first connection face and the abutment face of the body.

5. The method for manufacturing the head of the golf club as claimed in claim 1, wherein the second covering member is a tape.

6. The method for manufacturing the head of the golf club as claimed in claim 1, wherein the second covering member is formed from an ultraviolet light curing adhesive, wherein disposing the second covering member comprises:
applying the ultraviolet light curing adhesive to the first face of the cover; and
irradiating the cover with ultraviolet light to solidify the ultraviolet light curing adhesive as the second covering member.

7. The method for manufacturing the head of the golf club as claimed in claim 5, wherein the second covering member covers the first face and the second connection face of the cover.

8. The method for manufacturing the head of the golf club as claimed in claim 1, wherein the pressure is 10-25 psi.

9. The method for manufacturing the head of the golf club as claimed in claim 8, wherein heating the semi-finished product comprises heating the semi-finished product of the head of the golf club with a temperature of 121-177° C. for 30-60 minute.

10. The method for manufacturing the head of the golf club as claimed in claim 9, wherein the pressure is 15 psi, and wherein heating the semi-finished product comprises heating the semi-finished product of the head of the golf club with the temperature of 135-145° C. for 35-45 minute.

11. The method for manufacturing the head of the golf club as claimed in claim 8, wherein heating the semi-finished product comprises heating the semi-finished product of the head of the golf club with the temperature of 23-85° C. for 10-1440 minute.

12. The method for manufacturing the head of the golf club as claimed in claim 11, wherein the pressure is 15 psi, and wherein heating the semi-finished product comprises heating the semi-finished product of the head of the golf club with the temperature of 75-80° C. for 25-35 minute.

13. The method for manufacturing the head of the golf club as claimed in claim 1, wherein the first connection face of the body is spaced from the second connection face of the cover by a gap of 0.1-2 mm.

14. The method for manufacturing the head of the golf club as claimed in claim 1, wherein the abutment face of the body is spaced from the top surface of the body at a distance of 0.3-0.8 mm.

15. The method for manufacturing the head of the golf club as claimed in claim 1, wherein the abutment face of the body has a width of 4-7 mm.

16. A method for manufacturing a head of a golf club, comprising:
providing a body of the head and a cover, wherein the body has a top surface and an abutment portion, wherein the abutment portion is in a form of a recess on the top surface, wherein the abutment portion has an abutment face connected to the top surface via a first connection face, wherein the cover has a first face, a second face opposite to the first face, and a second connection face connected between the first face and the second face;
adhering the cover to the abutment portion of the body via an adhesive agent to obtain a semi-finished product of the head of the golf club, wherein the first connection face of the body is spaced from the second connection face of the cover by a gap;
disposing a covering member into the gap;
heating the semi-finished product of the head of the golf club to securely couple the cover with the abutment portion of the body via the adhesive agent; and
removing the covering members from the heated semi-finished product of the head of the golf club.

17. The method for manufacturing the head of the golf club as claimed in claim 16, wherein the covering member is formed from an ultraviolet light curing adhesive, wherein disposing the covering member comprises:
filling the gap with an ultraviolet light curing adhesive; and
irradiating the gap with ultraviolet light to solidify the ultraviolet light curing adhesive as the covering member.

18. The method for manufacturing the head of the golf club as claimed in claim 17, wherein the covering member extends from the gap to the top surface of the body and the first face of the cover.

19. The method for manufacturing the head of the golf club as claimed in claim 16, further comprising applying a pressure of 15-50 psi to both the body of the head and the cover to bond the cover to the abutment portion of the body via an adhesive agent.

20. The method for manufacturing the head of the golf club as claimed in claim 19, wherein heating the semi-finished product comprises heating the semi-finished product of the head of the golf club with a temperature of 107-132° C.

21. The method for manufacturing the head of the golf club as claimed in claim 16, wherein the first connection face of the body is spaced from the second connection face of the cover by a gap of 0.1-2 mm.

22. The method for manufacturing the head of the golf club as claimed in claim 16, wherein the abutment face of the body is spaced from the top surface of the body at a distance of 0.3-0.8 mm.

23. The method for manufacturing the head of the golf club as claimed in claim 16, wherein the abutment face of the body has a width of 4-7 mm.
